(19) United States
(12) Patent Application Publication
(10) Pub. No.: US 2015/0044336 A1
(43) Pub. Date: Feb. 12, 2015

(54) PROCESSING OF CRANBERRY FOOD PRODUCT INTO ASEPTIC PACKAGING

(71) Applicant: ASEPTIA, INC., Raleigh, NC (US)

(72) Inventors: Michael Conley DRUGA, Raleigh, NC (US); Pablo Marcelo CORONEL, Apex, NC (US); Thomas Henry KENNER, Asheboro, NC (US); Steven Lawrence CHAPMAN, Holly Springs, NC (US); James Michael DROZD, Raleigh, NC (US)

(21) Appl. No.: 14/451,786

(22) Filed: Aug. 5, 2014

Related U.S. Application Data
(60) Provisional application No. 61/862,948, filed on Aug. 6, 2013.

(51) Int. Cl. A23B 7/01; A23L 1/064; A23B 7/04; A47J 27/00

(52) U.S. Cl. CPC A23B 7/012; A47J 27/004; A23L 1/064; A23B 7/0433; A23V 2002/00
USPC 426/232; 426/392; 426/241; 99/325

(57) ABSTRACT

Methods and systems for processing food products, such as a cranberry food product, are provided. A cranberry food solution may be provided and heated to a first temperature. The cranberry food solution may then be cooled to a second temperature and the processed cranberry food solution may be filled aseptically into an aseptic package. The package filled with the cranberry food solution may be then cooled to a third predetermined time so that the cranberry food solution congeals in the package.

### CROSS-REFERENCE TO RELATED APPLICATIONS

The present application is a non-provisional application claiming the benefit of priority under 35 U.S.C. 119(e) to U.S. Provisional Patent Application No. 61/862,948, filed on Aug. 6, 2013, and entitled PROCESSING OF CRANBERRY FOOD PRODUCT INTO ASEPTIC PACKAGING, which is hereby incorporated in its entirety.

### BACKGROUND

Consumers enjoy eating various foods for the taste, nutrients, etc. These foods are packaged to be preserved for on-the-go convenience, shipping and storage efficiency, and other reasons. In addition to these factors, current food processing compromises the taste of food due to overcooking Additionally, conventional processing of foods like cranberries is inefficient. Moreover, foods, such as cranberries, must be cooked in septic aluminum cans which further degrade the quality of the foods.

### SUMMARY

Embodiments of the present invention are directed to methods, products and systems for processing cranberry food and/or other materials that may address the above issues. The pre-processed food product (e.g., cranberries) is processed by rapidly heating the cranberry food product to a first temperature and cooling the cranberry food product to a second temperature, both prior to packaging. Then, after a predefined time, the cranberry food product is delivered to aseptic packaging at the first temperature so that the packaged, cooked cranberry food product may be cooled to a third temperature where the cranberry food product may be congealed to cranberry sauce.

According to one embodiment, a method for processing cranberry food product is provided. A cranberry food solution is provided and heated to a first temperature. The cranberry food solution is then cooled to a second temperature and the processed cranberry food solution is filled aseptically into an aseptic package. The package filled with the cranberry food solution is then cooled to a third predetermined time so that the cranberry food solution congeals in the package.

According to another embodiment, a system for processing cranberry food product is provided. The system may include a heating device configured to heat a cranberry food solution to a first predefined temperature; a first cooling system configured to cool the cranberry food solution to a second predefined temperature for a predefined time; a fill system configured to fill the cooled cranberry food solution aseptically into an aseptic package; and a second cooling system configured to further cool the package filled with the cranberry food solution to a third predetermined temperature so that the cranberry food solution congeals in the package.

Other food processing solutions may be heated in the packaging container so that the packaging container becomes aseptic. This type of process can lead to over cooking in an attempt to sterilize the container. By having an aseptic package for the food solution, the process according to embodiments of the present application provides certainty that the container is aseptic and that the food is cooked at the correct temperature at a lower cost to be manufactured.

### DESCRIPTION OF THE DRAWINGS

FIG. 1 is a flow chart of an example of a method to process a cranberry food solution or other materials in accordance with some embodiments of the present invention.

FIG. 2 is a block schematic diagram of an exemplary system of processing a cranberry food solution or other materials in accordance with an embodiment of the present invention.

FIG. 3 is a block schematic diagram of an exemplary system of processing of a cranberry food solution in accordance with some embodiments of the present invention.

### DETAILED DESCRIPTION

Embodiments the present invention is described below with reference to flowchart illustrations and/or block diagrams of methods, apparatus (systems) and food products according to embodiments of the invention. It will be understood that each block of the flowchart illustrations and/or block diagrams, and combinations of blocks in the flowchart illustrations and/or block diagrams, can be implemented by elements of the system. The blocks of the flow chart can be performed at any order and should not be limited to the specific order described herein.

Described herein is a method 100 and system 200 for processing food products or other materials according to some embodiments to produce food products and/or cranberry food solutions 300.

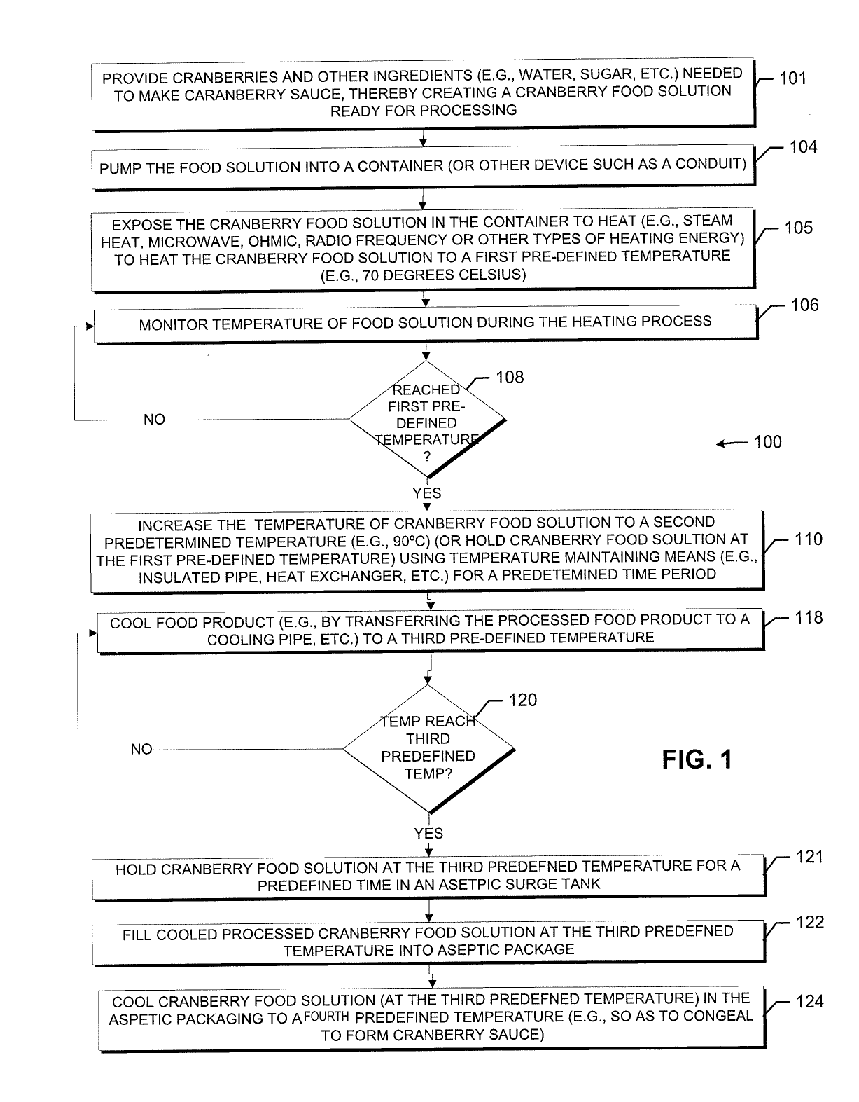

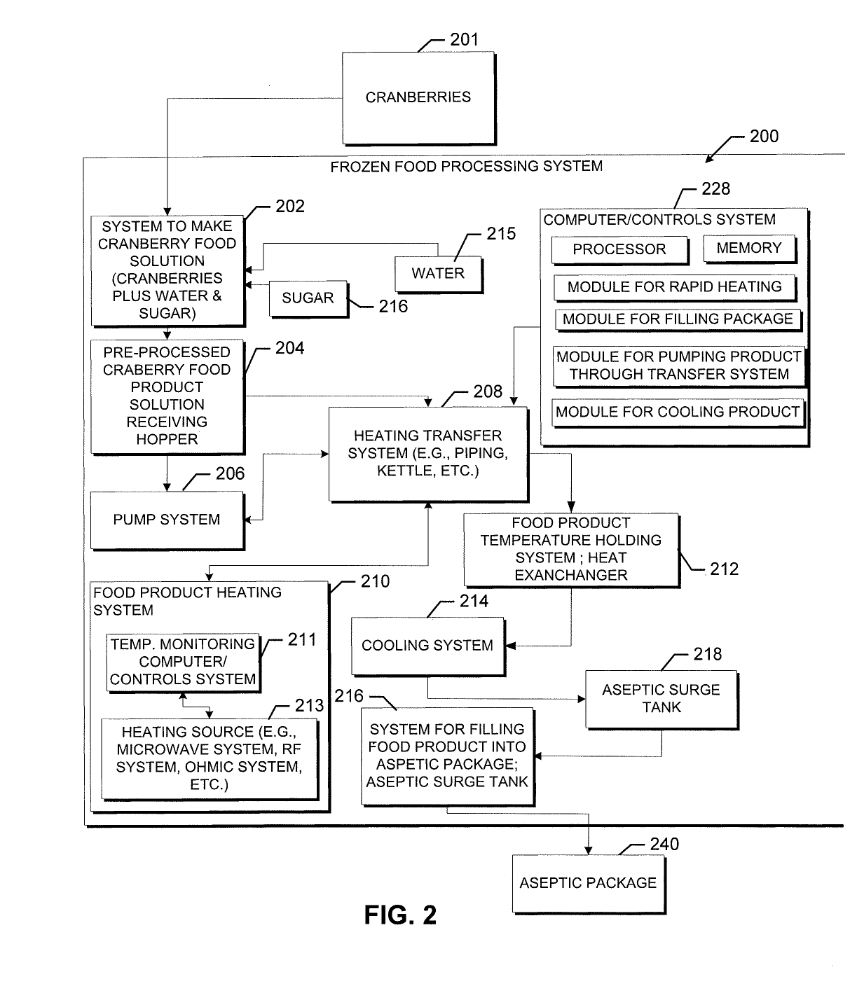

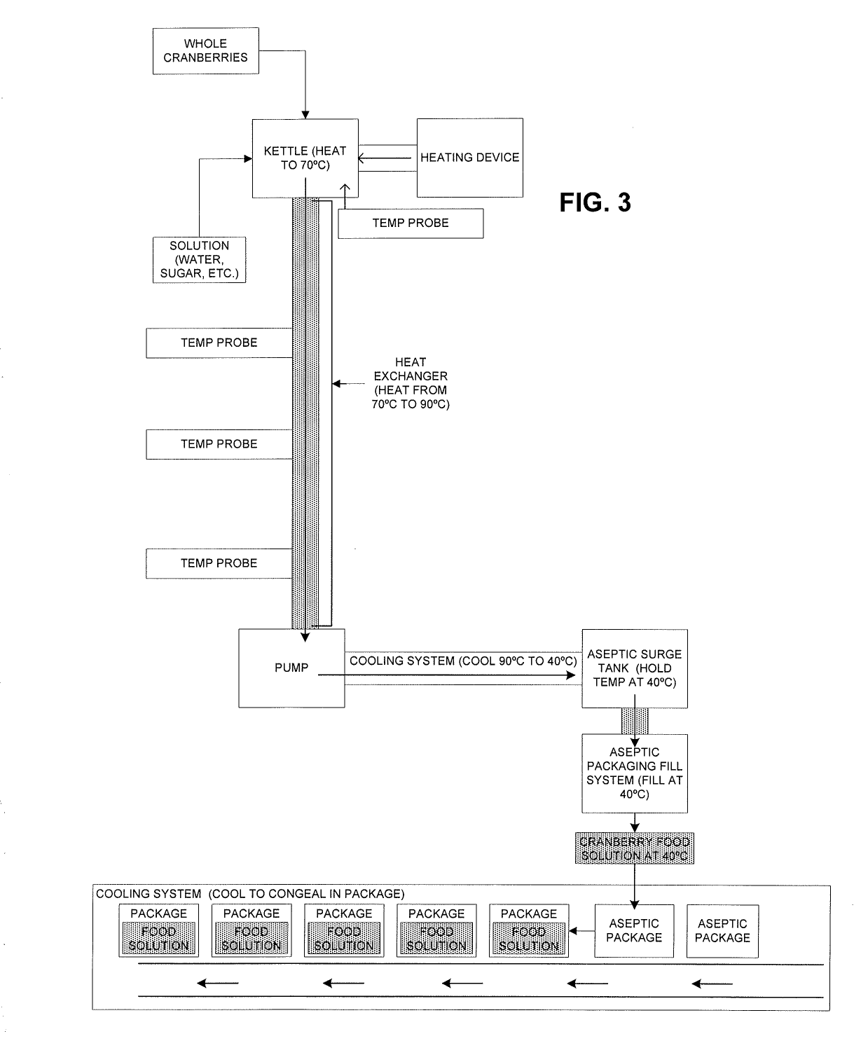

As mentioned above, a cranberry food product or solution is processed using heating and then cooled to a predefined temperature, and thereafter the cooled cranberry food solution is placed into one or more aseptic packages. The process, according to some embodiments, is discussed in more depth in the method of FIG. 1 and the systems of FIGS. 2 and 3. However, it should be understood that the elements and steps presented in the Figures and discussed relative thereto should not be so limited to any specific embodiment. Instead, various modifications and substitutions are also possible.

Referring first to FIG. 1, FIG. 1 is a flow chart of an example of a method to process cranberry food or other materials in accordance with some embodiments of the present invention. In block 101, a pre-processed cranberry food product is provided to a food processing system 200. This pre-processed food product could be whole cranberries. The pre-processed food product may contain food piece that may be larger than 1/16″ in cross-sectional diameter. In an embodiment, the pre-processed food product contains a mixture of ⅛-½″ pieces of cranberries.

The cranberries are combined with water and sugar (e.g., foods to make cranberry sauce) into a kettle to form a cranberry food solution or food product. The cranberry food solution in a pumpable state to allow the cranberry food solution to be pumped into the pipes (or other transfer means) through the system 200.

In block 104, the cranberry food solution is pumped (by a pump) from a food hopper into a conduit or other transfer means to a heating kettle). The pump is configured to pump the food solution from about 0.3-10 feet/second. This allows the food solution to be continuously pumped through a heating system and continuously filled into packages (as opposed to processing the food in separate batches).

In block 106, the pre-processed food solution is rapidly heated by heating, such as steam heat. The heating increases the temperature of the pre-processed food product to a first pre-determined temperature, such as about 70° C. The temperature of the food product during the heating may be monitored to ensure that the pre-processed food product reaches the first pre-determined temperature (as determined by block 108). The pre-processed food product may be heated to the first pre-determined temperature in a short duration of time

In one embodiment, the rapid heating process may use a volumetric heating process via a rapid heating device which could be a device that delivers electromagnetic energy (e.g., microwave energy, radio frequency energy, ohmic energy and/or other forms of volumetric heating) to the pre-processed food solution (e.g., a microwave device connected to a microwave generator so that microwave energy is focused into the pre-processed food solution from the microwave generator).

It should be understood that the heating in block 106 may be any type of heating to heat the cranberry food solution. It should be further understood that the cranberry solution may comprise a plurality of batches and enough to fill a plurality of packages. In this regard, a vat of cranberry food solution is heated simultaneously prior to filling of the packaging.

As stated above, the pre-processed food solution is heated to a first predetermined temperature. This first predetermined temperature may be preset or predetermined by the operator of the system such that the food product reaches such temperature and the system does not substantially heat the food product above such predefined temperature. According to one embodiment, this predetermined temperature generally relates to a temperature that a regulatory agency requires for a food product so that the food product is suitable for consumption. For example, the food solution (and/or food product) may be heated to a temperature of 90 degrees Celsius. In another embodiment, the food solution is heated to about 70 degrees Celsius in the kettle or container and then heated in a heat exchanger to about 90 degrees Celsius.

According to another embodiment, the predetermined temperature relates to a temperature that is somewhat greater than the temperature that a regulatory agency requires for a food product so that the food product is fit for consumption.

For the pre-determined temperature, the food solution and thus, the food product, exiting the heating process would have minimal variation in temperature. In an embodiment, the food solution exiting the rapid heating process would not vary more than +/−20° C. This maximum variation in temperature includes any point in the food product, including the temperature at the center of the cranberry food product.

If the heating process uses electromagnetic energy for heating, the food solution can be rapidly heated to the predetermined temperature and held at this predetermined temperature for a relatively short period of time as compared with thermal heating systems. As used herein, the term “critical zone” for processing fruits relates to the temperature range where accelerated degradation occurs to the product quality and nutrients. For cranberries, one may inactivate the native enzymes (which degrade the anthocyanins and other phenolic antioxidants in cranberries) as soon as possible, and then lower the food product's temperature out of their optimal activity temperature range (which may be substantially the above-discussed predetermined temperature). Once a cranberry has been ground or sliced this degradation accelerates rapidly as the fruits' individual cells rupture and thereby releasing enzymes contained in the fruit. The critical zone for fruits is typically between 10° C. and 70° C. according to some embodiments. Above 70° C., the process will have killed the spoilage microorganisms and completely inactivated all product degrading enzymes, but will continue degrading nutrients thermally until the product is cooled. One should minimize the time above this temperature range as well to minimize thermal degradation but less critical once the enzymes have been inactivated. Electromagnetic and other heating devices used in the heating process accomplish these goals due to the heating of the food product.

As briefly mentioned above, the temperature of the food solution and/or food product is monitored while being heated. Such monitoring may be performed using one or more temperature sensors at each desired location of the conduit. The monitored temperature at each location may be fed back into the system 228 and when the system determines that the food solution has reached the predefined temperature, the heating system 210 stops substantially heating the food solution so that the temperature of food solution does not continue to increase (or the food solution temperature is held constant).

In block 108, a determination by system 228 may be made as to whether the food product has reached the pre-determined temperature in the rapid heating process. The temperature may be monitored to determine that the pre-determined temperature has been reached, as mentioned above. A control system is used to control the rapid heating process that may integrate feedback from the monitored temperature. However, if the system 228 determines that predefined temperature is not reached, the method 100 continues back to and repeats block 106.

In block 110, the food solution exiting the heating system may need to be held at or near the exit temperature for a pre-determined length of time, where the exit temperature being the temperature of the food product at the moment of exiting the rapid heating system. This occurs in the food solution temperature holding system. The temperature holding system may be insulated pipes or other means for holding the food solution temperature for a predetermined time. The amount of time that the food solution temperature is kept constant may be relatively short. In an embodiment, the time the pre-processed food solution is contained in the holding system may be less than about two minutes. In another embodiment, the time in the holding system is less than one minute. In some embodiments, the temperature being held in the food holding system would be for aseptic processing.

In another embodiment, a heat exchanger may be employed to heat the cranberry food solution heated from the first predetermined temperature to a second predetermined temperature. For example, the cranberry food solution may be heated from 70 degrees Celsius to 90 degrees Celsius using a heat exchanger. The input of the conduit in the heat exchanger may be implemented to be connected to the output of the kettle container so that the cranberry food solution exiting the kettle container at the first predetermined temperature enters the heat exchanger at such temperature. The heat exchanger then may raise the temperature of the cranberry food solution to the second predetermined temperature. The heat exchanger may hold the cranberry food solution at the second predetermined temperature (as monitored by temperature probes) for a second predetermined time amount.

In block 118, since aseptic processing or aseptic packaging (e.g., packaging that has been substantially sterilized to 5 log reduction or more) is used as the packaging, the cranberry food solution is cooled in the food product cooling system to a third predetermined temperature. This cooling system may also be a heat exchanger such as a pipe in a cooling tube, shell in tube, and/or triple tube heat exchangers. Transfer of thermal heat occurs from the cranberry food solution through the transfer system to the cooling system so that the temperature of the food solution is more rapidly cooled than if the cooling system was not present. In one embodiment, the cooling system includes a cooling tube surrounding the transfer system (or pipe) and the cooling tube has cool water running therethrough to extract heat from the food solution in the transfer system.

The cooling time may be relatively short. In an embodiment, the time the processed food solution is in the food product cooling system may be less than about 20 minutes. In an embodiment, the time in the food product cooling system is less than about seven minutes. The cranberry food solution is cooled to the third temperature so that the cranberry food solution is not congealed.

In block 120, a determination is made whether the product is sufficiently cooled for aseptic packaging so that the temperature reaches the third predetermined temperature, as mentioned above. The third predetermined temperature is lower than the first and second predetermined temperatures but greater than the final/fourth predetermined temperature at the end of method 100 (step 124). The temperature of the food solution may be monitored while the food solution is being cooled in the cooling system to determine that the food solution is sufficiently cooled for aseptic packaging. A control system may be used to manage, monitor, and control the cooling process. In some embodiments, the food solution is cooled to about 40° C. prior to being transferred to the aseptic surge tank.

In block 121, the cranberry food solution is held at the third predetermined temperature for a predetermined time period using an aseptic surge tank in one embodiment. An aseptic serge tank may be a tank that is completely aseptic and is configured to hold the processed cranberry food solution at the third predetermined temperature. After heating the cranberry food product, the bacteria and the like is killed. As such, the cranberry food product should be kept aseptically processed. In that regard, the aseptic surge tank cools the aseptic cranberry food solution aseptically.

In block 122, the processed food solution is filled aseptically into an aseptic flexible package after the desired cooling temperature of the food solution is reached for the predetermined time period. The flexible package was sterilized using aseptic techniques prior to filling of the cranberry food solution. The package may be a single-serving flexible pouch, a large multiple serving container, a mass-quantity packaging, a flexible cardboard (or other non-aluminum) packaging, or other aseptic packaging.

The food solution as discussed herein is processed and placed in a package. In one embodiment, this package is aseptic so that it is substantially sterilized prior to adding the food solution.

The package could be flexible in that to obtain the contents of the packaging, the packaging is squeezed to deform the sides of the packaging forcing the contents of the interior of the packaging out of the packaging. In an embodiment, the package is flexible and can contain less than 16 ounces of food product and greater than one ounce of food product. In one embodiment, the package contains around 8 ounces of food product. In some embodiments, the package can be resealable.

In block 124, the cranberry food solution in the packaging is then cooled to a fourth predetermined temperature. This allows the cranberry food solution to congeal forming cranberry sauce.

In one embodiment, the third predetermined temperature is a temperature at which the cranberry food solution does not congeal but the fourth predetermined temperature does allow the food solution to congeal.

It should be understood that, in one embodiment, the heating of the food solution is cooked in a process where the food solution is packaged after the food solution is heated to a predefined temperature for a predetermined period of time to cook the food and after the food has been cooled to the third predetermined temperature (and eventually to the fourth predetermined temperature. In this regard, the food solution may not be heated while in the packaging according to one embodiment. According to another embodiment, the food solution may be filled in the packaging prior to the heating phase and then heated and cooled to cook the food product.

It should also be noted that the food solution may be continuously processed. In one embodiment, this may mean continuously pumping pieces of raw cranberry through a conduit from a large hopper to packages without interruption. As such, multiple batches of food solution may be all cooked through a single continuous process in a conduit and does not need to be separated until after heating and until the food solution is ready to be placed in a package and consumed.

FIG. 2 is a block schematic diagram of an exemplary system 200 of continuous processing the cranberry food product to shelf stable or refrigerated food products in accordance with some embodiments of the present invention. A food product 201 is provided to the system 200.

A food solution is created as discussed above. This may occur using a food solution system 202 which creates a cranberry solution by mixing cranberries and other ingredients for cranberry sauce (e.g., water and sugar).

The pre-processed food solution may be added to a receiving hopper 204 or any other container. The receiving hopper 204 holds the incoming pre-processed food solution until it is pumped into the system and may hold several batches of food solution. The receiving hopper 204 assures that the system has enough pre-processed food solution to be pumped in the system so that there are minimal or no gaps in food solution provided to the system during operation, according to some embodiments.

A pump system 206 is connected to the receiving hopper 204 and may be used to convey the food solution throughout the system 200. The pump system 206 may receive pre-processed food solution from the hopper and provide means for pumping the food solution throughout the system 200. The pump system 206 may be interconnected to a heating transfer system 208 allowing the pump system 206 to pump the food solution through the heating transfer system 208 to the heat exchanger 212, cooling system, aseptic surge tank 218 and into the filling system 216.

The heating transfer system 208 is used to interconnect the various systems, including the pump system 206, for processing. The heating transfer system 208 may be a system of interconnected pipes or conduits that connect one or more of the systems together, such as the pump system 206, the receiving hopper 204, the heating and cooling systems 210, 214, the filling system 216, etc. The transfer system 208 may allow for the food solution to easily transition from one of the various systems to another within the processing system. The transfer system 208 may be a system of pipes or conduits that are substantially hollow but allow for a pumpable substance to be pumped therethrough.

A heating system 210 is thermally and/or electrically communicative with the transfer system 208 and would increase the temperature of the pre-processed food product in the transfer system 208 to a pre-determined temperature, whereas the predetermined temperature is discussed above. The temperature of the food solution may be monitored to ensure that the pre-processed food product reaches the predetermined temperature. A computer system 228 (which is discussed below) could be used to control the temperature exiting the heating system 210. The pre-processed food product may be heated to the pre-determined temperature in a short duration of time, as previously discussed.

As stated above, at least a portion, or all, of the pre-processed food solution enters the heating system 210. In some embodiments, the pre-processed food solution enters the heating system 210 in pumpable form, as discussed above. In some embodiments, the pre-processed food may be pre-heated prior to entering the heating system 210, as stated above.

The heating system 210 may include at least one heating source 213. Each heating source 213 may be a system that delivers electromagnetic energy to the preprocessed food solution at one or more locations at the conduit from an electromagnetic energy generating source. For example, the heating source may be a thermal heat source device. In another embodiment, the heating source 213 may be a microwave generator (with a power of from about 50 KW to 2 MW) that generates and transfers microwave energy into the pre-processed food product from the microwave generator until the food solution or food product is heated to the above-discussed predetermined temperature. Alternatively, or additionally, the heating source 213 may be 1) a radio frequency (“RF”) energy generator that delivers RF energy to the food product until the food product or food product is heated to the above-discussed predetermined temperature, 2) an ohmic energy generator that delivers ohmic energy to the food product until the food product or food product is heated to the above-discussed predetermined temperature, and/or 3) other forms of volumetric or electromagnetic heating. The electromagnetic source delivers electromagnetic energy to the food solution which allows for even and quick heating of the food product since the food product is equally distributed throughout the solution (as opposed to thermal heating which requires heating from the outside of the food product first and heating the inside of the food product last). It should be understood that a heating source 213 need not be an electromagnetic source and could be any other source which rapidly heats the food product in a predetermined time duration.

The heating system 210 also may include a temperature monitoring computer/controls system 211 which manages the heating source 213 for delivering electric (e.g., thermal heat source, microwave, ohmic RF, etc.) energy to the food solution. For example, the temperature monitoring computer/controls system 211 controls the heating source 213 to turn it on and off for delivering energy to the food solution in the transfer system 208. Additionally, the temperature monitoring computer/controls system 211 monitors the temperature of the food solution while it is being heated by the heating source 213. When the food solution is heated to the predetermined temperature, the temperature monitoring computer/controls system 211 turns the heating source 213 off (or decreases the power thereof) so that the food product and/or food solution is not heated above such predetermined temperature.

A temperature holding system 212 may be employed to increase or hold the temperature of the food solution at or near the exit temperature for a pre-determined length of time, wherein such exit temperature is the temperature of the food solution at the moment of exiting the heating system 210. In one embodiment, according to the aseptic processing, the temperature holding system 212 may be insulated pipes or a portion of the transfer system 208 (which may be insulated, uninsulated, heated, cooled, etc.) to maintain a certain predetermined temperature of the food product for a predetermined time. In one embodiment, the temperature holding system 212 may be a heat exchanger.

The processed food solution may be cooled in a food product cooling system 214. The food product cooling system 214 may be a tube in a tube heat exchanger that is connected with other tubes or pipes of the transfer system 208. Such tube may surround a portion (e.g., a pipe) of the transfer system 208. The food product cooling system 214 may be used for the aseptic packaging process to cool the processed food product in the transfer system 208, as previously discussed with regard to blocks 118-120.

An aseptic surge tank 218 receives the food solution from the cooling system 214 to cool the food solution prior to filling the aseptic package.

A filling system 216 is used to the transfer the food solution into the package 240 from the aseptic surge tank 218. The filling system 216 may fill a pre-determined amount of food solution into the aseptic package 240. The package size may be virtually any size. Possible sizes of the packaging include but are not limited to 3 ounces, 8 ounces, 16 ounces, 1 liter, 2 liter, 5 liter, 55 gallon drums, 1 ton totes, tanker cars and other sizes. Additionally, the package 240 may be an aseptic (e.g., sterile) package or any other package.

As mentioned above, the system 200 delivers the processed food solution into the package 240 so that the processed food product is contained in the package 240. As previously discussed the package 240 may contain the cranberry food solution. The package containing the cranberry food solution is sealed for later use and for storing on a store shelf.

A computer/controls system 228 may be used to manage or control any aspects of the system 200. The computer/controls system 228 includes a processor and memory. Input and output devices are also included in the computer/controls system 228, such as a monitor, keyboard, mouse, etc. The computer/controls system 228 includes various modules, which includes computer code instructions to control the processor and memory. Any steps in methods 100 may be performed by the processor of the computer/controls system 228. The module for heating controls may control the heating system 210. The module for filling the package manages the filling of the package with processed food solution. The module for pumping food solution through the transfer system controls the pump system 206 and other devices so that the food solution (whether unprocessed or processed) through the transfer system 208 from the hopper 204, through the heating system 210, through the holding system 212 and all the way until filling the package 240. The module for cooling product controls cooling the food solution after the food solution has been processed, such as by actually providing cooling means and applying such cooling means while monitoring the temperature of the food solution until the food solution is cooled.

Other modules may also be included in the computer/controls system 228 and may work with any other device of the system 200.

In some embodiments, the processed food solution may be able to be stored on the shelf without refrigeration for six months or longer. In other embodiments, the processed food solution may be stored under refrigeration conditions for three months or longer.

The processed food solution is contained in the aseptic package. The aseptic package containing the cranberry food solution is sealed. In one embodiment, the sealed package contains less than eight ounces and greater than one ounce of food solution.

FIG. 3 is a block schematic diagram of an exemplary system of continuous processing of food products using heating in accordance with some embodiments of the present invention. As illustrated the product and solution is added to the food hopper. The food solution is illustrated by the shading the FIG. 3. A pump pumps the food solution through the heating phase and throughout the system.

Cranberries and water and sugar are added to a kettle. During the heating phase, the food solution is exposed to heating in the kettle so that the cranberry solution is heated to a first temperature, such as 70° C.

After the cranberry food solution is heated to the first temperature, the cranberry food solution is directly delivered to a heat exchanger. While exposed to the heat exchanger, the temperature is measured at several locations along the conduit with temperature probes. The temperature of the cranberry food solution in the heat exchanger increases from the first temperature (e.g., 70° C.) to a second temperature (90° C.).

In one embodiment, the food solution enters the temperature holding conduit (instead of a heat exchanger). In this regard, the first temperature is 90° C. and such temperature is held at 90° C. in the temperature holding conduit.

After the heat exchanger or temperature holding conduit, the cranberry food solution is transferred to the cooling system which cools the cranberry food solution to a third temperature, such as 40° C.

After the food solution is cooled, it is delivered to the aseptic surge tank. The aseptic surge tank holds the food solution at the third temperature (e.g., 40° C.) aseptically.

After the aseptic surge tank, the cranberry food solution is packaged using an aseptic fill packaging system while the cranberry food solution is at the third temperature (e.g., 40° C.).

FIG. 3 illustrates the packaging occurring on a conveyer belt so that the packaging system can continuously fill the packages on in an assembly-line fashion as illustrated. The filled packages with the cranberry food solution at the third temperature (e.g., 40° C.) may then then cooled to a fourth predetermined temperature (e.g., room temperature) so that the cranberry food solution congeals as cranberry sauce. The filled packages are then sealed and then may be consumed or placed on a store shelf.

It should be noted that any of the elements of the methods may be applicable to any other elements of any of the other methods. And as such, the blocks and related description apply to any elements.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for processing cranberry food product, the method comprising:
providing a cranberry food solution;
heating, using a heating device, the cranberry food solution to a first predefined temperature;
cooling the cranberry food solution to a second predefined temperature for a predefined time;
filling the cooled cranberry food solution aseptically into an aseptic package; and
further cooling the package filled with the cranberry food solution to a third predetermined temperature so that the cranberry food solution congeals in the package.

2. The method of claim 1, wherein the heating device comprises an electromagnetic heating source.

3. The method of claim 2, wherein the heating device comprises a microwave generator.

4. The method of claim 1, further comprising:
monitoring a cooling temperature of the cranberry food solution in the package filled with the cranberry food solution;
determining if the cooling temperature reaches the second predetermined temperature;
in response to determining that the cooling temperature reaches the second predetermined temperature, holding the cranberry food solution at the second predetermined temperature for the predefined time.

5. The method of claim 4, further comprising:
heating the cranberry food product to a third predetermined temperature for a predetermined time after the heating step but before the cooling step.

6. A system for processing cranberry food product, the system comprising:
a heating device configured to heat a cranberry food solution to a first predefined temperature;
a first cooling system configured to cool the cranberry food solution to a second predefined temperature for a predefined time;
a fill system configured to fill the cooled cranberry food solution aseptically into an aseptic package; and
a second cooling system configured to further cool the package filled with the cranberry food solution to a third predetermined temperature so that the cranberry food solution congeals in the package.

7. The system of claim 6, wherein the heating device comprises an electromagnetic heating source.

8. The system of claim 6, wherein the heating device comprises a microwave generator.

9. The system of claim 6, further comprising:
a temperature probe configured to monitor a cooling temperature of the cranberry food solution in the package filled with the cranberry food solution; and
a processor configured to determine if the cooling temperature reaches the second predetermined temperature;
wherein in response to determining that the cooling temperature reaches the second predetermined temperature, the first cooling system is configured to hold the cranberry food solution at the second predetermined temperature for the predefined time.

10. The system of claim 9, further comprising a plurality of temperature probes configured to measure an increase in temperature of the cranberry food solution during the heating.

11. The system of claim 6, wherein first cooling system comprises an aseptic surge tank configured to hold the cranberry food solution at the second predefined temperature for the predefined time.

12. The system of claim 6, wherein first cooling system comprises a system configured to cool the cranberry food solution from the first predefined temperature to the second predefined temperature prior to the predefined time.

13. The system of claim 6, further comprising:
a pump connected between the first cooling system and the heating device.
